(19) United States
(12) Patent Application Publication
(10) Pub. No.: US 2019/0257152 A1
(43) Pub. Date: Aug. 22, 2019

(54) LADDER SAFETY RAIL

(71) Applicant: Charles J. MacKarvich, Atlanta, GA (US)

(72) Inventor: Charles J. MacKarvich, Atlanta, GA (US)

(21) Appl. No.: 15/899,199

(22) Filed: Feb. 19, 2018

(51) Int. Cl. E06C 7/18; E06C 1/06

(52) U.S. Cl. CPC E06C 7/182; E06C 1/06

(57) ABSTRACT

A ladder safety rail for a ladder configured to reach an elevated surface of a structure against which the ladder rests is disclosed, the ladder having a plurality of side rails and a top rung extending between the side rails. The ladder safety rail can include a bracket comprising a longitudinal axis the bracket configured to be attached to a side rail of the ladder; and a handle configured to be attached to the bracket.

### TECHNICAL FIELD

This disclosure relates to a ladder safety rail. More specifically, this disclosures relates to a ladder safety rail for use on ladders to provide a safe transition from the ladder to an elevated surface, such as a roof.

### BACKGROUND

To access an elevated surface, such as a roof and the like, a user conventionally leans a ladder against a structure supporting the surface or the elevated surface itself and climbs the ladder. It can be difficult and dangerous, however, to transition from the ladder to the elevated surface. For example, the ladder sometimes cannot extend far beyond the edge of the elevated surface so that there is nothing for a user to grab and hold as a handle while transitioning to the elevated surface. In another example, the ladder can extend beyond the edge of the elevated surface but rungs of the ladder can prevent the user from walking through the side rails of the ladder to transition to the roof. Instead, the user must dangerously swing around the side rails or over the top rung.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

Disclosed is a ladder safety rail for a ladder configured to reach an elevated surface of a structure against which the ladder rests, the ladder comprising a plurality of side rails and a top rung extending between the side rails. The ladder safety rail can comprise a bracket comprising a longitudinal axis, the bracket configured to be attached to a side rail of the ladder, and a handle configured to be removably attached to the bracket.

Also disclosed is a system for converting a conventional ladder having a plurality of side rails and a top rung extending between the side rails into an OSHA compliant ladder having a ladder height at least thirty-six inches above an elevated surface of a structure against which the ladder rests. The system can comprise a bracket comprising a longitudinal axis, the bracket configured to be attached to a side rail of the ladder before the ladder is raised to the elevated surface, and a handle configured to be removably attached to the bracket.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The features and components of the following figures are illustrated to emphasize the general principles of the present disclosure. The drawings are not necessarily drawn to scale. Corresponding features and components throughout the figures may be designated by matching reference characters for the sake of consistency and clarity.

FIG. 1 is a perspective view of a pair of ladder safety rails coupled to a ladder, the ladder safety rails each comprising a bracket and a handle, according to one aspect.

FIG. 2 is a side perspective view of one of the brackets of FIG. 1.

FIG. 3 is a second side perspective view of the bracket of FIG. 2.

FIG. 4 is a top elevational view of the bracket of FIG. 2.

FIG. 5 is a perspective view of a retaining clamp of the bracket of FIG. 2 showing the clamp securing the bracket to the ladder.

FIG. 6 is a side elevational view of the bracket and ladder of FIG. 5.

FIG. 7 is a top elevational view of the bracket and ladder of FIG. 5.

FIG. 8 is a perspective view of the ladder safety rails of FIG. 1 coupled to a ladder with the handles removed.

FIG. 9 is a front elevational of the ladder safety rails of FIG. 1 coupled to a ladder.

FIG. 10 is a side elevational of the ladder safety rails of FIG. 1 coupled to a ladder.

FIG. 11 is a perspective view of the ladder safety rails of FIG. 1 coupled to a ladder, showing the ladder being used to access an elevated surface.

FIG. 12 is magnified view of FIG. 11.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a ladder safety rail and associated methods, devices, and various apparatus. The ladder safety rail can be selectively attachable to a ladder to provide a safe transition from the ladder to an elevated surface, such as a roof. For example, the ladder safety rail can be attached to the two side rails of a conventional ladder to provide the user of the ladder a handle that extends above and/or over the edge of the elevated surface. It would be understood by one of skill in the art that the disclosed ladder safety rail is described in but a few exemplary embodiments among many. No particular terminology or description should be considered limiting on the disclosure or the scope of any claims issuing therefrom.

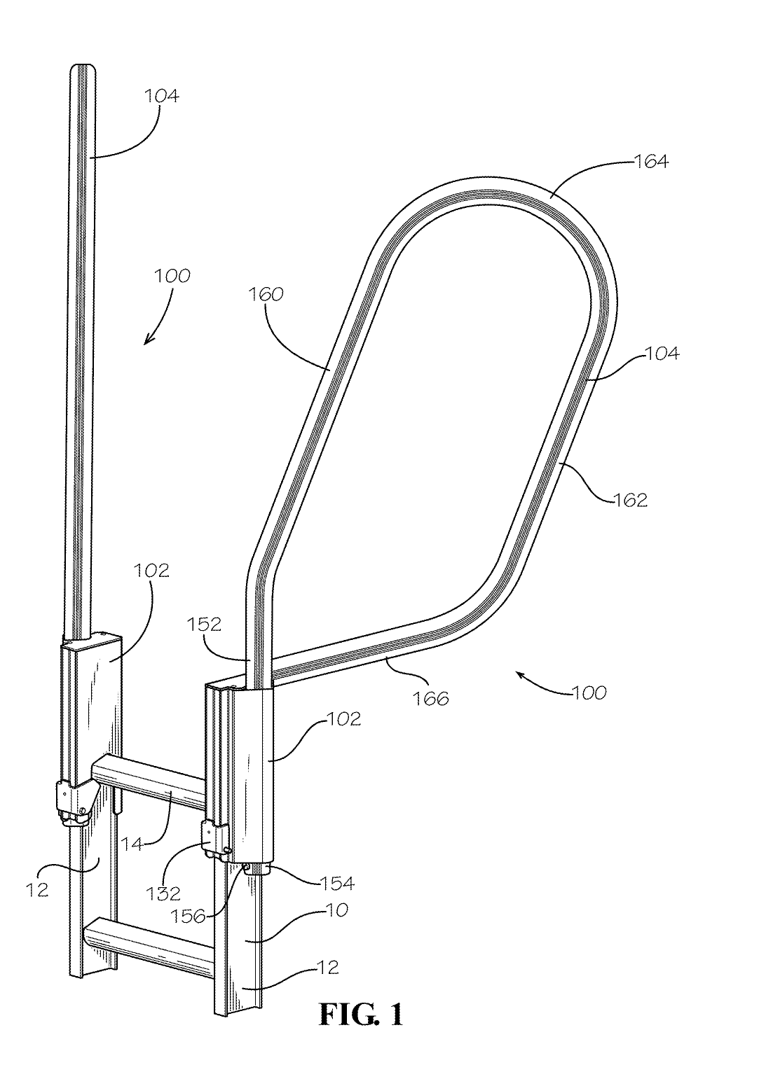

FIG. 1 shows a perspective view of a pair of ladder safety rails 100 coupled to a ladder 10. In one aspect, each ladder safety rail 100 can comprise a bracket 102 coupled to the ladder 10 and a handle 104 coupled to the bracket 102. Each bracket 102 can be positioned on a respective side rail 12 of the ladder 10 to secure the bracket 102 and the handle 104 to the ladder 10.

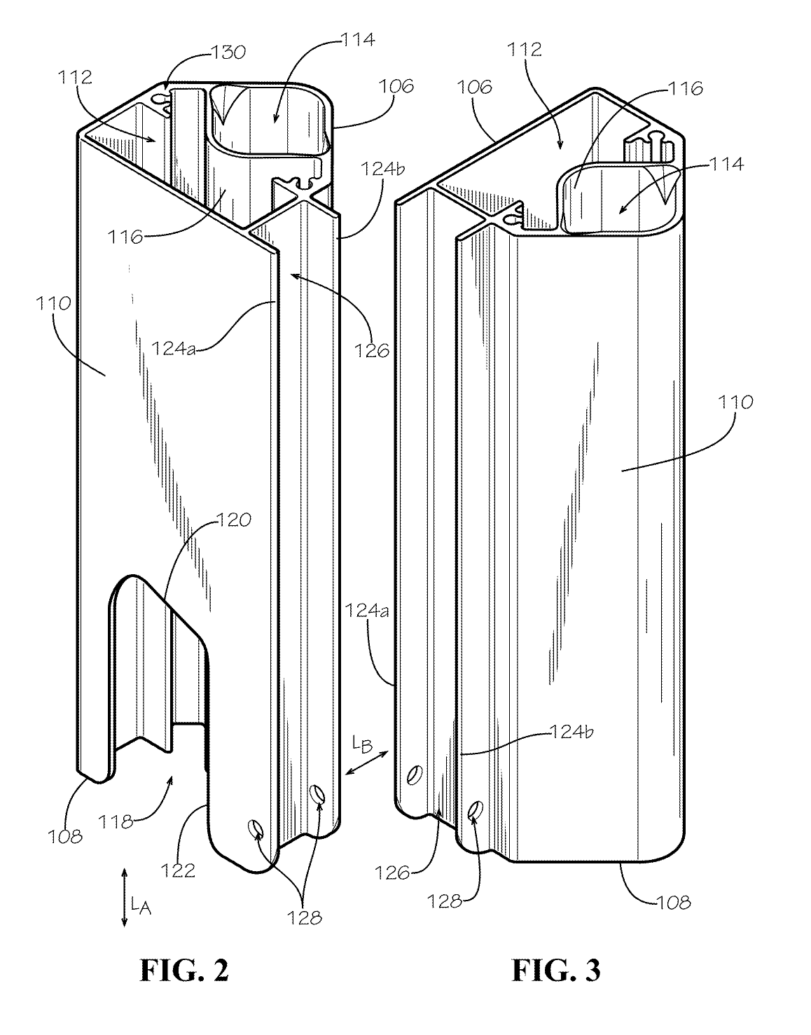

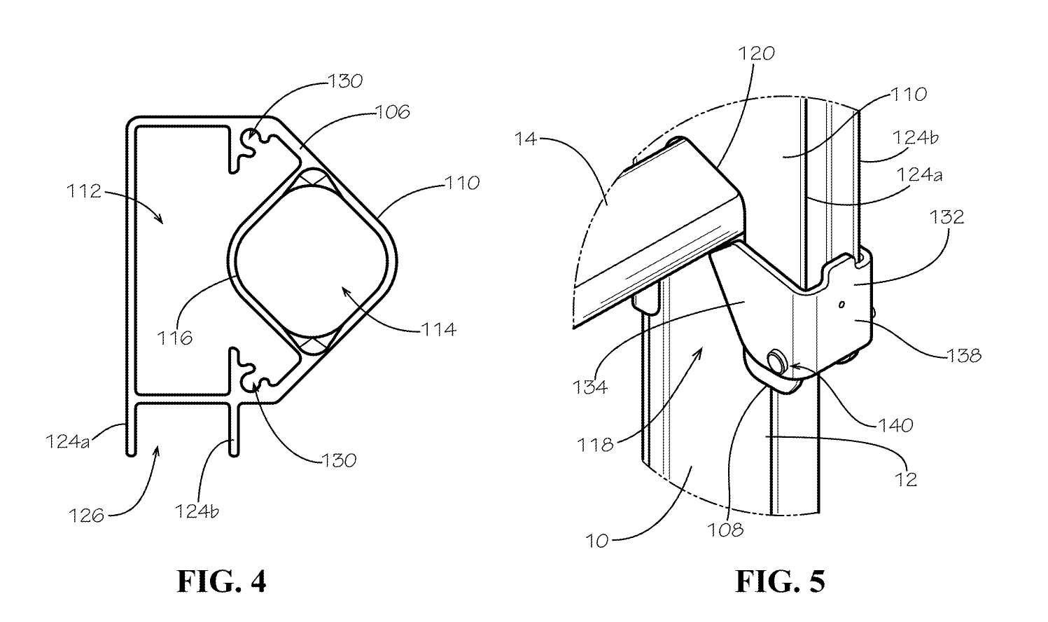

The bracket 102 is illustrated more clearly in FIGS. 2-4. The bracket 102 comprises a top end 106, an opposed bottom end 108, and an outer wall 110 extending between the top end 106 and the bottom end 108. In one aspect, a first longitudinal duct 112 and a second longitudinal duct 114 can be defined in the bracket 102, each duct 112, 114 extending from the top end 106 to the bottom end 108. In this aspect, the first duct 112 can be separated from the second duct 114 by a sidewall 116 extending from the top end 106 to the bottom end 108. The first duct 112 can be sized and shaped to matingly engage a portion of the side rail 12 of the ladder 10 and the second duct 114 can be sized and shaped to matingly engage a portion of the handle 104. The bracket 102 can be formed from extruded metal, such as aluminum, or other extruded or cast metals, plastics, or any other suitable material, to define the longitudinal ducts 112,114.

A notch 118 can be defined in the outer wall 110 from the bottom end 108 of the outer wall 110 and extending upwards toward the top end 106 of the outer wall 110. In one aspect, a top portion 120 of a notch wall 122 can be at an acute angle relative to a longitudinal axis L_{A} of the bracket 102, the top portion 120 configured to engage a top rung 14 (shown in FIG. 1) of the ladder 10.

A plurality of longitudinal ribs 124a,b can extend outwards away from the outer wall 110 a predetermined rib width. In one aspect, the ribs 124a,b can be formed adjacent to the first duct 112 and can extend from the top end 106 to the bottom end 108 of the bracket 102. In this aspect, the ribs 124a,b can be spaced from each other a predetermined rib distance so that a rib gap 126 can be defined between the ribs 124a,b, the rib gap 126 extending from the top end 106 to the bottom end 108 of the bracket 102. In one aspect, a pin bore 128 can be defined in each of the ribs 124a,b adjacent to the bottom end 108. In this aspect, the pin bore 128 can have a bore axis L_{B} substantially normal to the longitudinal axis L_{A} of the bracket 102.

In another aspect, at least one screw hole 130 can be defined in the outer wall 110 at the top end 106 of the bracket 102. In this aspect, the screw hole 130 can extend in a direction substantially parallel to the longitudinal axis L_{A} of the bracket 102.

With reference now to FIGS. 5-7, the bracket 102 can further comprise a retaining clamp 132 configured to securedly couple the bracket 102 to the top rung 14 of the ladder 10. In one aspect, the retaining clamp 132 comprises a first wall 134 spaced from and substantially parallel to a second wall 136 (shown in FIG. 7), and a third wall 138 extending between the first wall 134 and the second wall 136. In this aspect, the first wall 134 can be spaced from the second wall 136 such that the longitudinal ribs 124a,b of the bracket 102 can be positioned between the first and second walls 134, 136. A pin hole 140 can be defined in the first wall 134 and the second wall 136 of the retaining clamp 132.

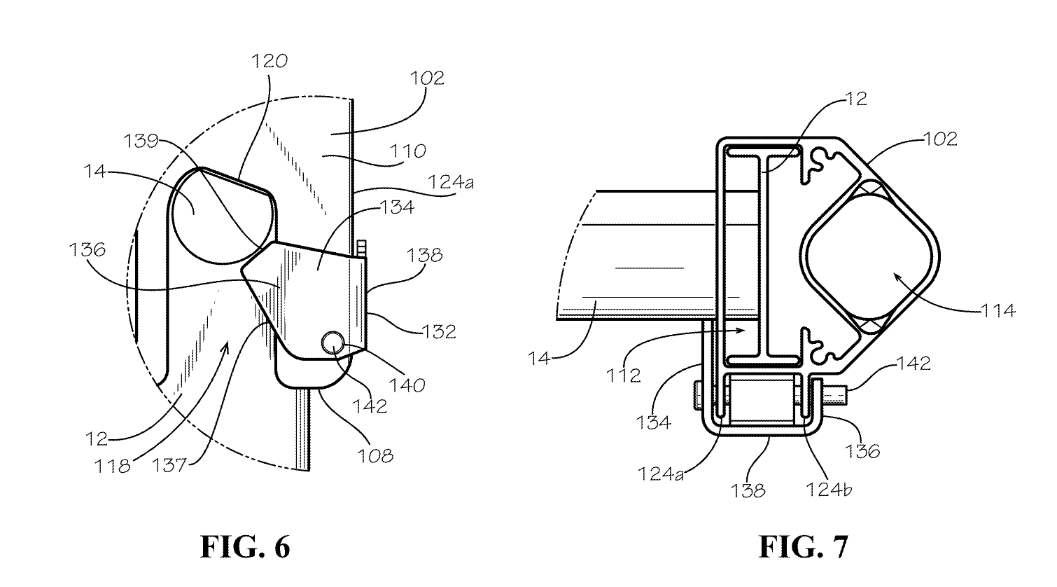

In one aspect, the pin hole 140 of the first wall 134 and the second wall 136 can be substantially coaxially aligned with the pin bore 128 defined through the ribs 124a,b, and a pin 142 can be inserted therethrough to rotatably couple the retaining clamp 132 to the ribs 124a,b of the bracket 102. A pin 142 can be a clevis pin held in place with a cotter pin or any other suitable fastener or mechanism that can hold the pin 142 in place in the pin bore 128 and the pin hole 140. In this aspect, the retaining clamp 132 can be rotatable about and between a first locked position, in which the first wall 134 of the retaining clamp 132 overlies at least a portion of the notch 118 defined in the outer wall 110 of the bracket 102, and a second unlocked position in which the first wall 134 of the retaining clamp 132 is spaced from the notch 118. In another aspect, with the retaining clamp 132 coupled to the bracket 102 and in the first position, the first wall 134 can have a first side 137 (shown in FIG. 6) at an acute angle relative to the longitudinal axis L_{A} of the bracket 102, and a second side 139 (shown in FIG. 6) substantially normal to the first side 137. In the current aspect, the retaining clamp 132 can be biased into the first locked position by gravity. In other aspects, the retaining claim 132 can be biased into the first locked position by a spring or other biasing element, such as a coiled spring or a spring clip. In other aspects, the retaining claim 132 can be manually actuated into the second locked position with a knob or a bolt comprising a threaded shank that can push the retaining clamp 132 towards the second locked position.

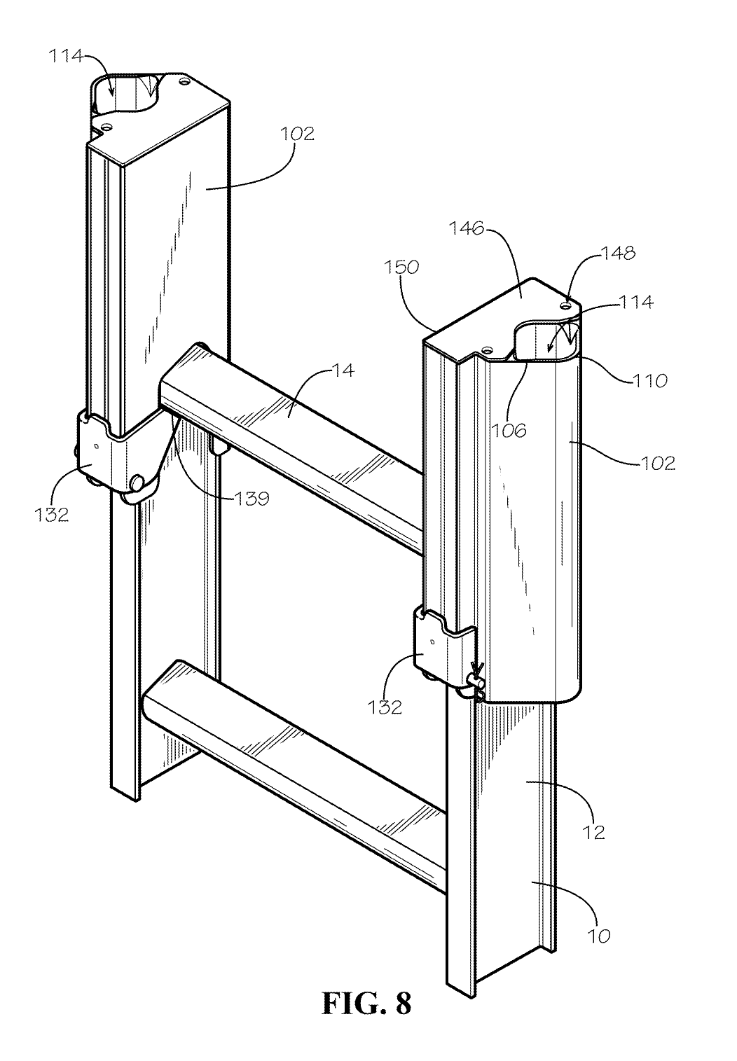

In one aspect, the bracket 102 can further comprise a cover 146 as illustrated in FIG. 8. In this aspect, the cover 146 can be sized and shaped to overlie a portion of the top end 106 of the bracket 102. For example, the cover 146 can be sized and shaped to cover the top end 106 of the bracket 102 except for the second duct 114. At least one screw hole 148 can be defined in the cover 146 so that a fastener such as a screw and the like can be inserted through the screw hole 148 of the cover 146 and the screw hole 130 of the bracket 102 to secure the cover 146 to the bracket 102. With the cover 146 secured to the bracket 102, an outer edge 150 of the cover 146 can be substantially flush with the outer wall 110 at the top end 106 of the bracket 102.

The handle 104 is shown in FIGS. 1, 9, and 10. In one aspect, the handle 104 can be an elongate and/or tubular handle 104 formed from extruded metal, such as aluminum, or other extruded or cast metals, plastics, or any other suitable material. The tubular handle 104 can comprise a mounting portion 152 configured to slidingly engage the second duct 114 of the bracket 102. That is, the mounting portion 152 of the handle 104 can be sized and shaped so that the mounting portion 152 can slide through the second duct 114 until a distal end 154 of the handle 104 exits the second duct 114 below the bottom end 108 of the bracket 102. In another aspect, a biasing clip 156 can be coupled to the distal end 154. The biasing clip 156 can comprise at least one prong 158, or tab, that is selectively movable about and between a first relaxed position, in which the prong 158 extends away from the handle 104 and a second depressed position, in which the prong 158 does not extend away from the handle 104. In some aspects, the biasing clip 156 can be a V-shaped spring clip mounted inside the handle 104. The biasing clip 156 can comprise two prongs 158, with one at each end of the “V” that extends through holes defined in the mounting portion 152 to extend away from the handle 104 in the first relaxed position.

In use, described more fully below, each prong 158 can be depressed by a user to allow the distal end 154 of the handle 104 to be inserted into the second duct 114 of the bracket 102. The wall of the second duct 114 can keep the prong 158 depressed as the mounting portion 152 of the handle 104 slides through the second duct 114. When the distal end 154 exits the second duct 114 below the bottom end 108 of the bracket 102, the prong 158 can bias outward to the first relaxed position, thereby fixedly attached the handle 104 in place relative to the bracket 102. In another aspect, an internal wall of the second duct 114 can be slotted and/or chamfered to allow the prongs 158 to readily slide through the second duct 114.

In one aspect, the handle 104 can further comprise at least one of an upper rail 160 coupled to the mounting portion 152, a lower rail 162 substantially parallel to the upper rail 160, a curved rail 164 that couples the upper rail 160 to the lower rail 162, and a connecting rail 166 that couples the lower rail 162 to the mounting portion 152.

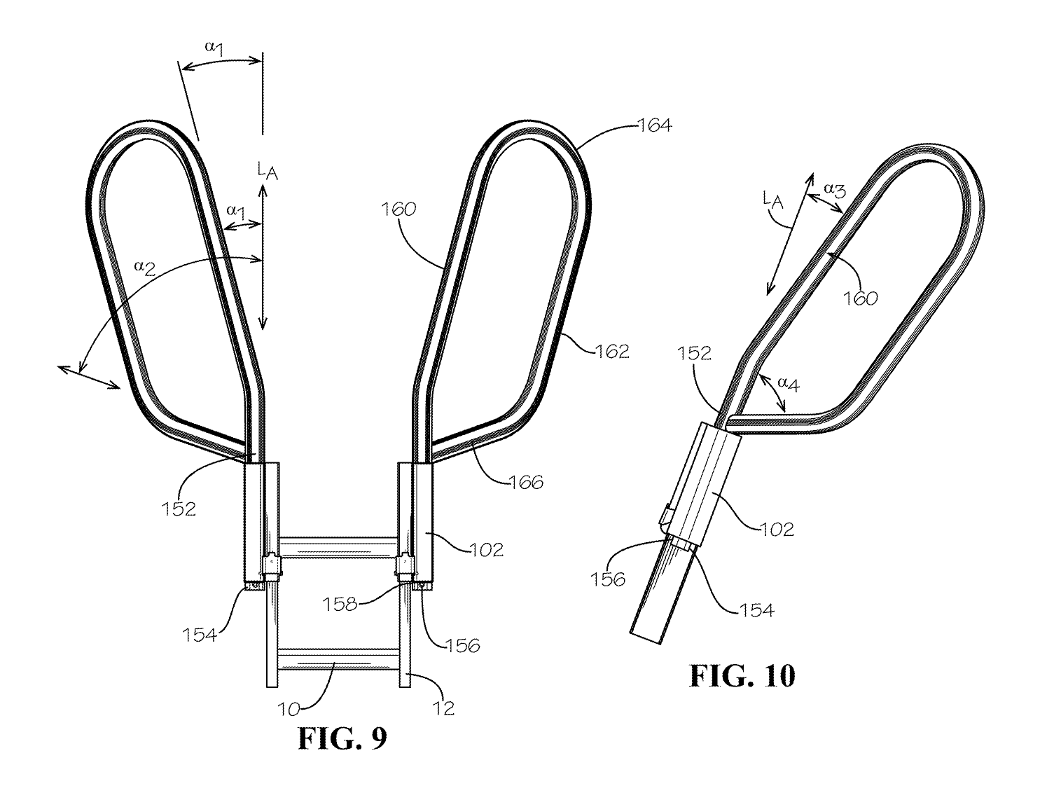

With the handle 104 attached to the bracket 102, a portion of the handle 104 can extend away from the bracket 102 at a plurality of angles relative to the longitudinal axis L_{A} of the bracket 102. As illustrated in FIG. 9, in one aspect, the upper rail 160 can have a rail axis at a first acute angle α₁ to the longitudinal axis L_{A} of the bracket 102 when viewed from a front of the ladder 10. In another aspect, the connecting rail 166 can have a rail axis at a second acute angle α₂ to the longitudinal axis L_{A} of the bracket 102 when viewed from a front of the ladder 10. As illustrated in FIG. 10, the rail axis of the upper rail 160 can be at a third acute angle α₃ to the longitudinal axis L_{A} of the bracket 102 when viewed from a side of the ladder 10, and the rail axis of the connecting rail 160 can be at a fourth acute angle α₄ to the longitudinal axis L_{A} of the bracket 102 when viewed from a side of the ladder 10. That is, with reference to FIG. 10, the longitudinal axis L_{A} of the bracket 102 can be substantially co-axially aligned with the side rail 12 of the ladder 10 and the third and fourth angles α₃, α₄ can be in a plane containing the longitudinal axis L_{A} and the bore axis L_{B} of the bracket 102, and the first and second acute angle α₁, α₂ can be in a plane containing the longitudinal axis L_{A} and orthogonal to the bore axis L_{B}.

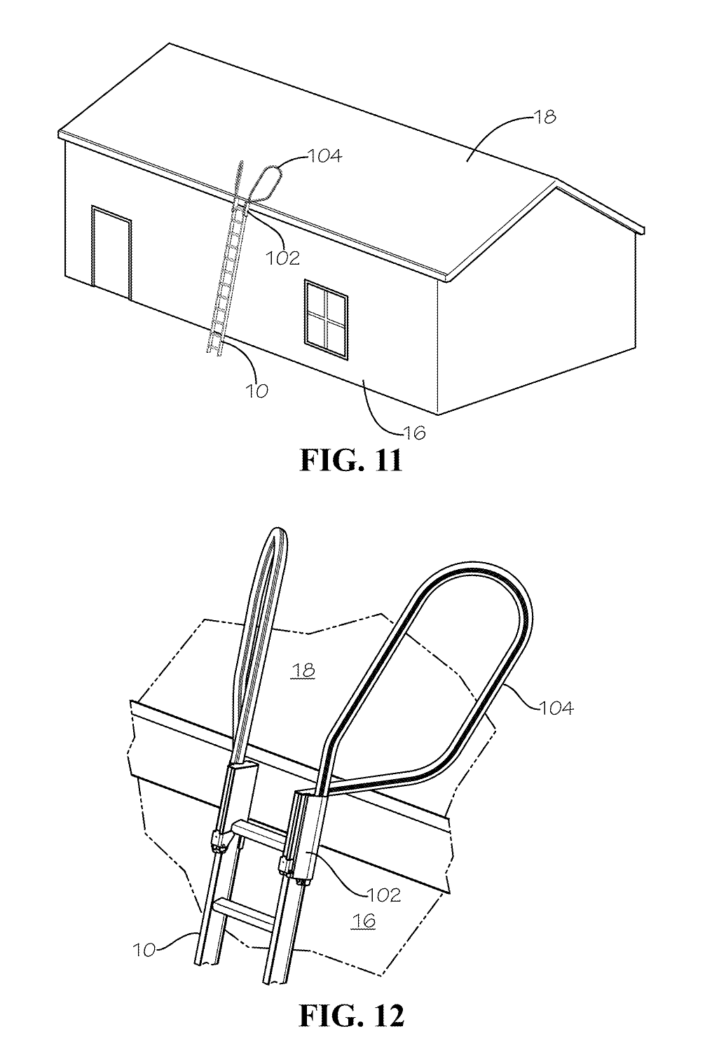

In use, the angles α₁, α₂, α₃, α₄ formed between the rails 160, 166 of the handle 104 can stabilize the ladder 10 and/or assist the user on getting on the elevated surface. For example, the third angle α₃ formed between the upper rail 160 and the longitudinal axis L_{A} of the bracket 102, and the fourth angle α₄ formed between the connecting rail 166 and the longitudinal axis L_{A} of the bracket 102 can cause at least portions of the handle 104 to overhang the elevated surface of a structure against which the ladder 10 rests in a direction substantially parallel to the bracket 102 and/or the side rails 12 of the ladder 10. That is, with the ladder 10 leaned against a supporting structure, such as a building 16 (illustrated in FIGS. 11 and 12), at least a portion of the handle 104 can overhang the elevated surface, such as a roof 18 of the building 16. This overhang can make it safer and easier for a user of the ladder safety rail 100 to transition from the ladder 10 to the roof 18, and from the roof 18 to the ladder 10.

In another example, the second angle α₂ formed between the connecting rail 166 and the longitudinal axis L_{A} of the bracket 102 can cause at least portions of the handle 104 to overhang the elevated surface in a direction substantially normal to the bracket 102 and/or the side rails 12 of the ladder 10. That is, with the ladder 10 leaned against a supporting structure, such as a building 16 (illustrated in FIGS. 11 and 12), at least portions of the handle 104 can overhang the elevated surface, such as a roof 18, in a direction that prevents or restricts undesired sideways movement of the ladder 10. Thus, if the ladder 10 starts to slide in a direction substantially normal to the side rails 12 of the ladder 10 (i.e., parallel to the top rung 14 of the ladder 10), the connecting rail 166 that overhangs the elevated surface can contact the elevated surface to prevent or restrict further movement of the ladder 10.

To assemble the ladder safety rail 100, the first duct 112 of a bracket 102 can be positioned over the side rail 12 of the ladder 10 and the bracket 102 can be inserted onto the side rail 12. In one aspect, the bracket 102 can be positioned with the second duct 114 facing away from the ladder 10 and the notch 118 defined in the outer wall 110 facing the opposing side rail 12 of the ladder. The side rail 12 can slide through the first duct 112 until the top rung 14 of the ladder 10 contacts the top portion 120 of the notch wall 122. As the side rail 12 slides through the first duct 112, the top rung 14 of the ladder 10 can urge the retaining clamp 132 to rotate to the second unlocked position so that the top rung 14 can slide past the retaining clamp 132. With the bracket 102 in position on the side rail 12 and the top rung 14 of the ladder engaging the top portion 120 of the notch wall 122, the retaining clamp 132 can be biased to the first locked position to securedly couple the bracket 102 to the side rail 12. Note that the bracket 102 can be coupled to the ladder 10 on the ground (i.e., before the ladder 10 has been raised). If a second handle 104 is desired, a second bracket 102 can be coupled to the other side rail 12 of the ladder 10.

The mounting portion 152 of the handle 104 can be positioned over and then inserted into the second duct 114 of the bracket 102. In one aspect, the handle 104 can be oriented so that the connecting rail 166 of the handle 104 extends outward (i.e., away from the ladder 10). To insert the handle 104 into the bracket 102, the prongs 158 can be moved to the second depressed position by chamfers defined in the second duct 114 so that the prongs 158 do not extend away from the handle 104 and the mounting portion 152 can be inserted into the second duct 114. The mounting portion 152 can slide through the second duct 114 until the distal end 154 of the handle 104 extends from the second duct 114 adjacent the bottom end 108 of the bracket 102. The prongs 158 can then be biased to the first relaxed position, in which the prongs 158 extend away from the handle 104 and prevent the handle 104 from being inadvertently removed from the bracket 102. Note that the handle 104 can be coupled to the bracket 102 either before or after the ladder 10 has been raised. When the handle 104 is formed from extruded aluminum or other light material, the handle 104 is easier for a user to carry up a ladder 10 and insert into the bracket 102 at the top of the ladder 10 as it leans against a building 16 without having to push the ladder 10 away from the building 16.

To remove the ladder safety rail 100 from the ladder 10, the prongs 158 can be pushed inward to the second depressed position so that the prongs 158 do not extend away from the handle 104 and the mounting portion 152 can be removed from the second duct 114. Note that the handle 104 can be removed from the bracket 102 either before or after the ladder 10 has been raised and without pushing the ladder 10 away from the building 16. To remove the bracket 102 from the side rail 12, the user can rotate the retaining clamp 132 to the second unlocked position in which the first wall 134 of the retaining clamp 132 is spaced from the notch 118. With the retaining clamp 132 in this unlocked position, the bracket 102 can then slide off of the side rail 12 of the ladder 10. Note that the bracket 102 can be removed from the ladder 10 either before or after the ladder 10 has been raised.

In some aspects, the ladder safety rail 100 can optionally comprise one or more knobs defining threaded shanks extending through threaded bores in the outer wall 110 into either or both of the ducts 112,114. Turning the knobs can drive the threaded shanks into the ducts 112,114 to grip the side rail 12 in the duct 112 or the handle 104 in the duct 114. Actuation of the knobs can thereby prevent accidental removal of the bracket 102 from the ladder 10 and the handle 104 from the bracket 102. In other aspects, the knobs can be replaced with threaded bolts that can be driven into the ducts 112,114.

OSHA regulations call out a 36 inch minimum height that a ladder 10 must extend above an elevated surface, such as a roof's landing surface. In one aspect, the handle 104 can have a handle height at least 36 inches so that the extension height of the ladder 10 with the ladder safety rail 100 coupled to the ladder 10 cannot be set lower than 36 inches.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A ladder safety rail for a ladder configured to reach an elevated surface of a structure against which the ladder rests, the ladder comprising a plurality of side rails and a top rung extending between the side rails, the ladder safety rail comprising:
a bracket comprising a longitudinal axis, the bracket configured to be attached to a side rail of the ladder; and
a handle configured to be removably attached to the bracket.

2. The ladder safety rail of claim 1, wherein the bracket is configured to be attached to a side rail of the ladder prior to the ladder being raised to the elevated surface.

3. The ladder safety rail of claim 1, wherein an angle formed between a portion of the handle and the longitudinal axis of the bracket causes at least a portion of the handle to overhang the elevated surface.

4. The ladder safety rail of claim 1, wherein an angle formed between a portion of the handle and the longitudinal axis of the bracket causes a portion of the handle to overhang the elevated surface in a direction substantially normal to the side rails of the ladder.

5. The ladder safety rail of claim 1, wherein a first angle formed between a portion of the handle and the longitudinal axis of the bracket causes at least a portion of the handle to overhang the elevated surface in a first direction, and a second angle formed between a portion of the handle and the longitudinal axis of the bracket causes a portion of the handle to overhang the elevated surface in a second direction that is different than the first direction and substantially normal to the longitudinal axis of the bracket.

6. The ladder safety rail of claim 1, wherein the bracket comprises a top end, an opposed bottom end, and an outer wall extending between the top end and the bottom end, and wherein a first longitudinal duct and a second longitudinal duct are defined in the bracket from the top end to the bottom end.

7. The ladder safety rail of claim 6, wherein the first duct is configured to matingly engage a portion of the side rail of the ladder and the second duct is configured to matingly engage a portion of the handle.

8. The ladder safety rail of claim 1, wherein the bracket comprises a top end, an opposed bottom end, and an outer wall extending between the top end and the bottom end and wherein a notch is defined in the outer wall from the bottom end of the outer wall and extends upwards toward the top end of the outer wall.

9. The ladder safety rail of claim 8, wherein a top portion of a notch wall of the notch is at an acute angle relative to the longitudinal axis of the bracket, and wherein the top portion of the notch wall is configured to engage the top rung of the ladder.

10. The ladder safety rail of claim 1, wherein the bracket comprises a top end, an opposed bottom end, and an outer wall extending between the top end and the bottom end, wherein a notch is defined in the outer wall, wherein the notch is configured so that a portion of the top rung of the ladder is positionable in the notch, and wherein the bracket further comprises a retaining clamp configured to securedly couple the bracket to the top rung of the ladder.

11. The ladder safety rail of claim 10, wherein the retaining clamp is rotatable about and between a first locked position, in which a first wall of the retaining clamp overlies at least a portion of the notch, and a second unlocked position in which the first wall of the retaining clamp is spaced from the notch.

12. The ladder safety rail of claim 1, wherein the bracket comprises a top end, an opposed bottom end, and an outer wall extending between the top end and the bottom end, wherein a first longitudinal duct and a second longitudinal duct are defined in the bracket, wherein the first duct is configured to matingly engage a portion of the side rail of the ladder, and wherein the handle comprises a mounting portion configured to slidingly engage the second duct of the bracket.

13. The ladder safety rail of claim 12, wherein the mounting portion of the handle is configured so that the mounting portion can slide through the second duct until a distal end of the handle exits the second duct below the bottom end of the bracket.

14. The ladder safety rail of claim 1, wherein the handle comprises a biasing clip coupled to a distal end of the handle, and wherein the biasing clip comprises at least one prong that is movable about and between a first relaxed position, in which the prong extends away from the handle and a second depressed position, in which the prong does not extend away from the handle.

15. The ladder safety rail of claim 14, wherein the bracket comprises a top end, an opposed bottom end, and an outer wall extending between the top end and the bottom end, wherein a longitudinal duct is defined in the bracket, wherein the duct is configured to matingly engage a portion of the handle, and wherein the prong is configured to be selectively depressed by a user to allow the distal end of the handle to be inserted into the duct of the bracket.

16. A system for converting a conventional ladder having a plurality of side rails and a top rung extending between the side rails into an OSHA compliant ladder having a ladder height at least thirty-six inches above an elevated surface of a structure against which the ladder rests, the system comprising:
a bracket comprising a longitudinal axis, the bracket configured to be attached to a side rail of the ladder before the ladder is raised to the elevated surface; and
a handle configured to be removably attached to the bracket.

17. The system of claim 16, wherein the handle is configured to be attached to the bracket after the ladder has been raised to the elevated surface.

18. The system of claim 17, wherein an angle formed between a portion of the handle and the longitudinal axis of the bracket causes at least a portion of the handle to overhang the elevated surface.

19. The system of claim 17, wherein an angle formed between a portion of the handle and the longitudinal axis of the bracket causes a portion of the handle to overhang the elevated surface in a direction substantially normal to the side rails of the ladder.

20. The system of claim 17, wherein a first angle formed between a portion of the handle and the longitudinal axis of the bracket causes at least a portion of the handle to overhang the elevated surface in a first direction, and a second angle formed between a portion of the handle and the longitudinal axis of the bracket causes a portion of the handle to overhang the elevated surface in a second direction that is different than the first direction and substantially normal to the longitudinal axis of the bracket.
